(19) United States
(12) Patent Application Publication
(10) Pub. No.: US 2016/0241972 A1
(43) Pub. Date: Aug. 18, 2016

(54) Modifications for Hearing Deficiencies

(71) Applicant: Garth W. Gobeli, Albuquerque, NM (US)

(72) Inventors: Garth W. Gobeli, Albuquerque, NM (US); Stephen L. Mills, Albuquerque, NM (US)

(21) Appl. No.: 14/624,126

(22) Filed: Feb. 17, 2015

(51) Int. Cl. H04R 25/00

(52) U.S. Cl. CPC H04R 25/554; H04R 25/50; H04R 2225/55

(57) ABSTRACT

This invention relates to a hearing assistance that corrects hearing deficiency of individuals and thus serves to provide a realistic hearing capability/experience to those suffering from hearing loss. The modification of the frequency response of earbuds is the method of modification discussed here. Additionally the invention corrects the deficiencies in hearing that are introduced by the large non-uniformities in earbud sound response as a function of audio frequency for every user. Similar deficiencies in the earpiece speakers of smartphones are addressed. Modifications used for smartphones include accommodation for the limited sound transmission bandwidth of all cell-phones.

### CROSS REFERENCE TO RELATED APPLICATIONS

This is a Continuation in Part to application Ser. No. 14/519,949: Filing Date Oct. 21, 2014: Confirmation No: 4789: Attorney Docket No: GOBELI 003.

### STATEMENT REGARDING FEDERALLY SPONSORED R&D

None.

### NAMES OF PARTIES TO A JOINT RESEARCH AGREEMENT

None.

### STATEMENT REGARDING PRIOR DISCLOSURES

None.

### FIELD OF THE INVENTION

This invention relates to a hearing assistance that corrects hearing deficiency of individuals and thus serves to provide a realistic hearing capability/experience to those suffering from hearing loss. The modification of the frequency response of earbuds is the method of modification discussed here. Additionally the invention corrects the deficiencies in hearing that are introduced by the large non-uniformities in earbud sound response as a function of audio frequency for every user. Similar deficiencies in the earpiece speakers of smartphones are addressed. Modifications used for smartphones include accommodation for the limited sound transmission bandwidth of all cell-phones.

### DESCRIPTION OF PRIOR ART

“Discussion on Hereditary Hearing Loss Overview”, by M. Cohen, et. al., www.ncbig.nlm.nih.gov/books/NBK1434]. Some hearing loss can be a conductive loss, an otosclerosis loss, or due to some forms of hereditary hearing loss. The most common hearing issue for these types of loss shows a significant hearing deficiency at all audio frequencies in the range of about 40 Hz to 10,000 Hz. This loss is nearly independent of the audio frequency over this entire range and ranges from a modest loss of some 30 dB too much more severe losses of greater than 65 db. When this type of loss occurs for children who have a normal hearing range that covers the frequency spectrum from about 15 Hz to more than 24,000 Hz such earbud corrections should cover that range.

“In the ZON: Excellence and Innovation in Hearing Instrument Design”, by Jason A. Galster, et. al., Starkey Laboratories, Inc., Eden Prairie, Minn.—https.Starkeypro.com/pdfs/technical-papers/MISCO400-EE-ST.pdf. There is a discussion to the effect that existing digital hearing aids are not capable of providing this type of correction over the complete audio spectrum needed for satisfactory function, especially for the high frequency range from 4000 Hz to 8000 Hz. Such digital hearing aids are mostly used to correct modest hearing losses that occur as an individual ages. Their maximum amplification reaches only 33 dB near 4000 Hz and falls significantly for both lower and higher frequencies.

U.S. Pat. No. 8,150,080 discusses an automatic method of identifying an individual's “hearing genetic feature” and automatically selects a correction pattern that will “best” address the user's hearing issues. This proposes to define an individual's specific genetic feature. Success requires a DNA-based genetic feature and then to “prescribe” a hearing aid correction that is unique to that individual's genetic feature identification. This patent lists several DNA features that are associated with hereditary hearing loss but does not describe the methods or approaches to implementing the hardware-software approaches to implementation.

U.S. Pat. No. 7,650,004 describes a method for individuals to fit their own hearing aids via a series of try #1 sound vs. try #2 sound and determining which is preferable. This is another way of how an audiologist “prescribes” a hearing aid for each individual. In the case of the audiologist the measurement of the individual's audiogram forms the basis for the fitting of the hearing aid performance. There are many patents regarding hearing aids. They all are with respect to very small instruments that can be easily worn in a semi invisibly manner and which use very small batteries that must be changed after a few days of use.

Examples are U.S. Pat. Nos. 8,300,862 and 4,396,806. In all such hearing aids, the very small battery and its low voltage preclude significant amplification (greater than 33 dB at the peak at about 3800-4000 Hz), but amplification values are substantially lower at all significantly higher and lower frequencies. In addition these hearing aids are “fitted” to the individual and must by law be dispensed by a licensed audiologist.

U.S. Pat. No. 8,787,606 describes a hearing instrument that employs electronic compensation with analog circuitry that successfully provides large corrections for presbyacusis (age-related hearing loss). Stable amplification reaching 70 dB at 4000 Hz and near 80 dB at 8000 Hz that permits hearing correction for hearing losses classified as “severe presbyacusis” is described. Earbuds with modified driver circuits are used to present the corrected sound spectrum to the user's ears.

Recently, a new type of earbud design and manufacture was introduced that uses multiple drivers together with very small cavities coupled to each driver. Each cavity is of a different size and all components (up to 6 drivers per earbud) are contained in the housing of each earbud itself. Since all drivers are of the same size and quality there is no significant improvement of sound quality over an extended frequency range. The invention described here will also improve the response of this earbud design.

Bestar Electronics Technologies Inc. at http://www.bestartech.com/speakers-micro-speakers-c-1 2 4-l-en.html shows a complete line of small rectangular micro-speakers used in cell phones. All such speakers show a “resonance” peak near 1000-1200 Hz. The response for higher frequencies exhibits a modestly changing (plus-or-minus about 10 dB). The response for lower frequencies shows a continuous drop off of response that declines by as much as 80 dB at 20 Hz. We discuss a correction directed to alleviating this problem for voice communications of all telephones, both cell and landline.

In summary, this invention provides a “one-size-fits-all” solution to hearing improvement for all individuals.

### SUMMARY OF THE INVENTION

The object of this invention is to provide a hearing correction for conductive and otosclerosis hearing loss that is basically independent of the audio frequency over the range of about 16 Hz to 24000 Hz. Thus it provides an excellent hearing experience to everyone that uses these modified earbuds. The instrument will provide such correction and has a simple audio amplitude adjustment control that permits user control of the correction over the amplitude range of 10 dB to 70 dB. This is accomplished by modifying the basic response of the earbud micro-speaker itself. Thus it provides a universal one-type-correction-fits-all approach that permits easy and efficient modification that is controlled by the user. Everyone using earbuds will experience a similar improvement in listening to sound, be it music or speech.

Another issue that we address is the very poor speech comprehension experienced by everyone when using a telephone, especially a cell phone (smartphone). This deficiency is caused by two factors:
(a) The limited bandwidth for transmission of speech from the service provider.
(b) The deficiency of the earpiece speaker frequency response.

In the United States the voice channel for all telephones covers the frequency range from 400 Hz to 3400 Hz. This small range does not cover the speech sounds of sibilants (s, f, th above 7000 Hz) nor the fricatives (ch, sh, etc. near 6000 Hz). This results in a significant loss of comprehension and makes speech communication poor for everyone, but especially for the hearing impaired.

This issue is further aggravated by the frequency response of the small rectangular speakers used in smartphones. These speakers show a resonant peak near 1100 Hz. At higher frequencies the response changes by plus-or-minus 15 db in for frequencies up to 22,000 Hz. This change has very little impact on comprehension. However toward lower frequencies there is a drastic, straight-line fall of about 50 dB at 300 Hz and of 90 dB at 20 Hz. This covers the speech sounds of vowels (a, e, i, o, u) and of the basic consonants (m, n, v, b, d etc.). This low frequency sound loss is the fundamental reason that telephone conversations are basically have difficulty with speech comprehension.

The utilization of this invention will significantly improve speech comprehension for all users of telephones, but most significantly for the hearing impaired.

### BRIEF DESCRIPTION OF THE DRAWINGS

FIG. 1 is a typical audiogram of a person with a common type of severe hearing loss, such as ostosclerotic loss or genetic loss. Note that the plot is actually log plot of (hearing loss in dB) vs. log of (audio frequency in Hz).

FIG. 2 is a graph of a typical earbud response on the same representative plot as that of FIG. 1.

FIG. 3 is a diagram of the method for properly measuring the frequency response of earbud micro-speakers.

FIG. 4 is a diagram of the electronic components of the digital signal processing (DSP) components of the instrument and a diagram of the physical unit.

FIG. 5 is a sketch of one embodiment of the invention

FIG. 6 is a graph of a typical earpiece speaker of a smartphone on the usual dB response as a function of log(frequency).

FIG. 7 is a diagram of the electronic components and method of insertion of the speaker driver modifications of this invention into the circuits of a typical smartphone.

FIG. 8 is a diagram of the method of modifying the frequency response of a smartphone rectangular speaker and impressing that correction onto the transmission properties of a smartphone.

### DETAILED DESCRIPTION OF THE INVENTION

### Definitions

Audiogram: A graph of a person's hearing loss having a decibel scale of hearing loss (dB-HL) as a function of audio frequency (Hz). It is measured by an audiologist, as part of the fitting procedure for a hearing aid.

Hearing aid (HA): An electronic instrument that is classified by the Food and Drug Administration (FDA) as an air conduction device as specified by FDA regulations. Only licensed audiologists are permitted to dispense and sell “hearing aids”. “Hearing aids” are uniquely fitted for an individual rather than for a class of hearing loss.

Personal sound amplifier (PSA): A small amplifier designed as a one-unit-fits-all listening instrument and carried in a small case. Common functions, such as amplification control, “equalizer” functions, etc. are frequently included. PSAs can be electronically filtered and then the amplification can approximately correct for hearing loss of particular types. Most notably various degrees of presbyacusis can be corrected by such filtering (U.S. Pat. No. 8,787,606).

Earbuds: A pair of micro-speakers with rubber tips that are worn inserted into the ear canals. They are connected to a sound source, such as an MP3 player, a cell phone, etc. They are very light. They are in contrast to “ear phones” or “head phones” that have pads that cover the conch of the ear.

Earbud audio characteristic: The amplitude response of an earbud micro-speaker when driven at various frequencies of sound at a constant amplitude electrical input. The characteristic shows a peak in response near the natural mechanical resonance frequency of the speaker. This frequency for earbuds with 9 mm to 11 mm drivers is about 4000 Hz. The response falls off for both lower and higher frequencies. This characteristic must be modified or suppressed in order to provide an accurate correction for a person's hearing loss.

DSP: Digital signal processor: Usually a semiconductor chip with many electronic components that operates digitally to process signals. Current digital hearing aids are examples of DSP functionality.

Blue tooth: An electronic device that provides means of short range FM transmission of sound from a “base”: unit, such as a MP3 player, cell phone, etc. to a receiving unit, worn in/on the ear. It removes the requirement of wires connecting the units.

Smartphone: A series of cell phones that have considerable computer facility embedded so that a large number of capabilities with respect to not only communications but also locally displayed information are possible. Smart phones use a very small rectangular earpiece speaker for sound production by the device.

### BEST MODE OF THE INVENTION DESCRIPTION

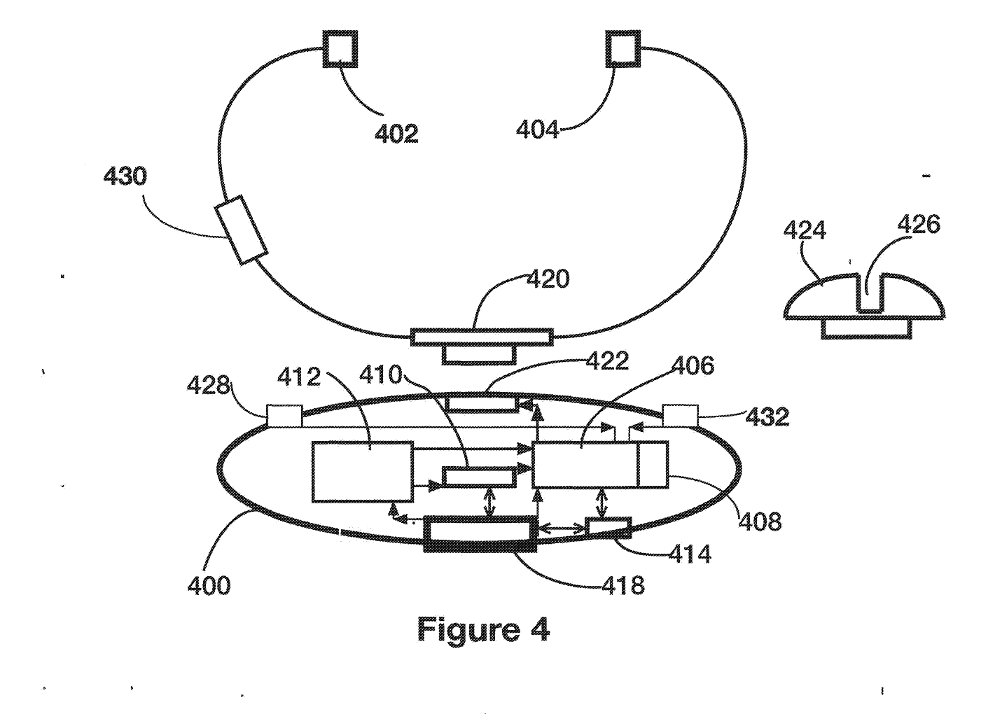

FIG. 4 represents the best mode of the present invention.

### How to Make the Invention

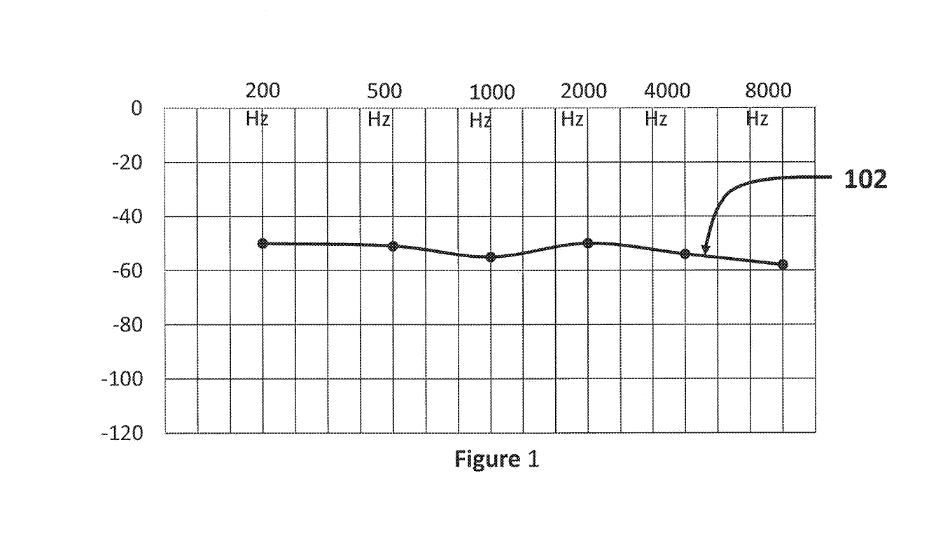

FIG. 1 is an audiogram of a person that suffers a type of significant hearing loss that is described as ostosclerotic or as conductive. The curve (102) indicates a hearing loss of 60 dB+/−5 dB over the complete auditory range from 400 Hz to 8,000 Hz that is almost frequency independent. This type of loss can sometime also be caused by genetic inheritance at birth. This range covers much of the sound range of human speech and shows that this person will have a real problem with speech comprehension. A better analysis of the complete auditory issues would be for the covered range to extend further into the low frequency region, helpfully to 30 Hz or so (30 Hz is very close to the frequency of the lowest key of a piano). Similarly an extension of the high frequency range to values greater than 24,000 Hz would be desirable, since infants and youths have a high frequency hearing range that can reach above 25,000 Hz. This also covers the range appropriate to cases of early genetic loss. Both the high and low frequency extensions of the hearing range of correction are important to the proper hearing for infants and also for ages reaching into the teen years.

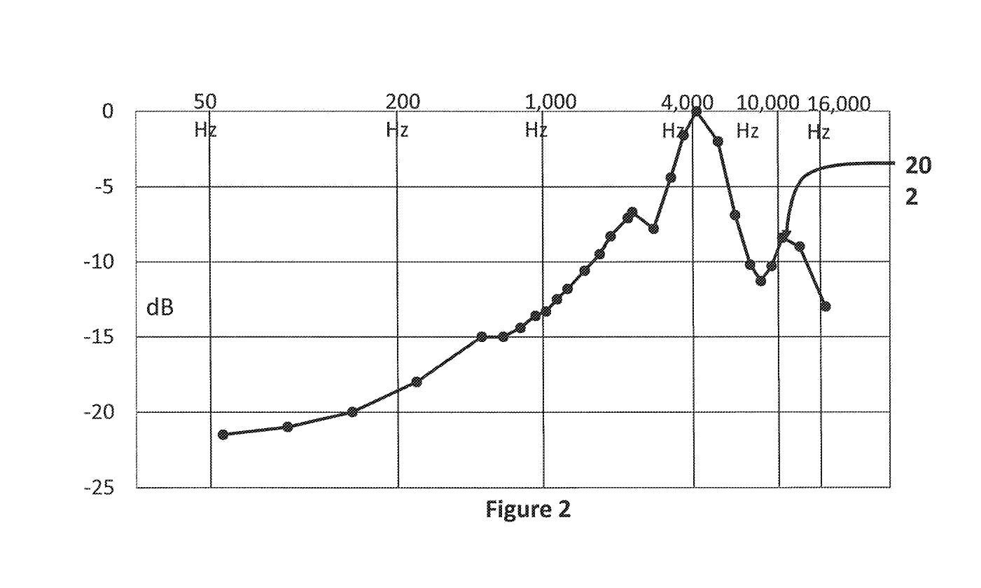

FIG. 2 shows the frequency response (202) of an earbud speaker that has a 10 mm driver a 6-micron membrane and a rare earth magnet (neodymium-iron-boron or NdFeB). The data are normalized to a value of zero at the 3900 Hz peak value. This earbud was selected as being of a reasonably high quality while being only moderately expensive. Other earbuds have very similar response curves that differ only in the resonant peak location and details of the fall-off at both higher and lower frequencies. Additionally, the absolute value of the response maximum will depend on driver size, magnet type, membrane thickness, and mounting details.

In conventional Hi-Fi audio systems several speakers of different sizes and fabrication details are melded together to provide an audio frequency response that is reasonably independent of the audio frequency over the range from 30 Hz to 20,000 Hz. This is done by using passive cross-over circuits that manage the mix of sound of regions between the frequency peaks of the speakers in the array. There is no reason to attempt to force the “flat” response onto a single speaker because the power requirements of providing this response would be very costly in the driver circuits involved. Also the multi-speaker approach permits variations in the mechanical components of each speaker to help provide the desired effects.

In the case of hearing via the very small micro-speakers of digital hearing aids or with earbuds, their small size and manner of use (they are worn inserted into the ear canal) clearly rules out this multi-speaker approach to providing a desired frequency independent response over the entire audio range from 30 Hz to 20,000Hz.

When in use, the earbuds form a closed system that is comprised of:
A. The ear bud micro-speaker and the earbud tip pad that provides a seal to the proximal end of the ear canal;
B. The ear canal itself; that is a tubular passage to the eardrum; and
C. The eardrum itself; that seals the distal end of the system.

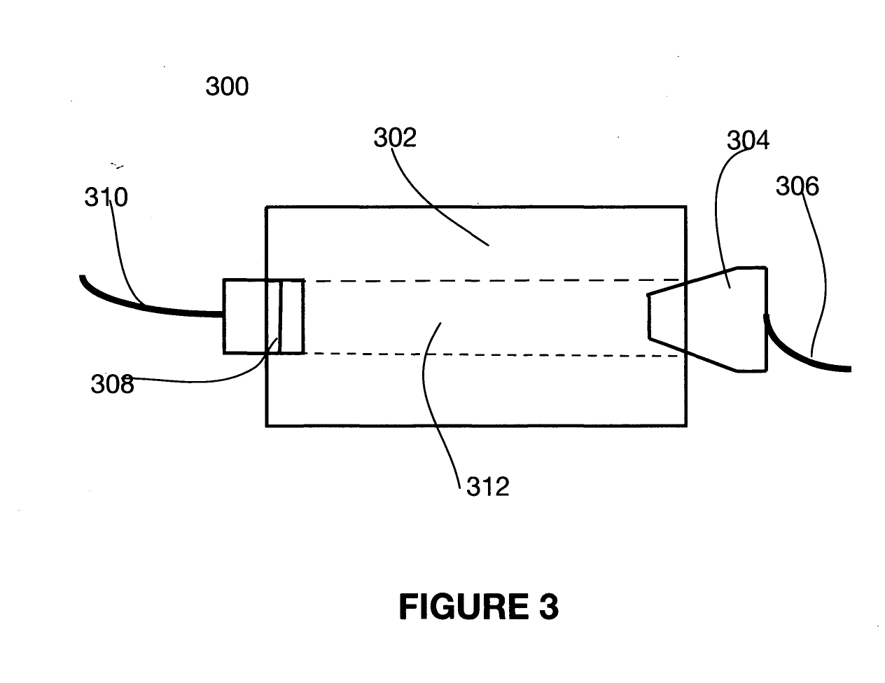

When measuring the earbud micro-speaker response it is IMPORTANT that the above usage profile be replicated in the experimental measurement apparatus. As shown in FIG. 3, to this end, the apparatus uses a small rubber tube (302) with a thick wall. The earbud with a silicone rubber tip sealing the “proximal” end (304) is inserted into the tubular space (312). A small sensitive microphone (308) seals the opposite or “distal” end of the tube. The separation between earbud tip and microphone is about 10 mm. By using this method, the system of “earbud to ear canal to eardrum” reproduces the backside loading of the speaker that exists when in use in a person's ear.

FIG. 2 shows one of several earbud measurements that illustrate the damped-resonant characteristic of all earbuds.

The small size of earbud speakers and the method they use to couple sound to the user's ears permit a simple and direct approach to the solution of correcting this sound problem. Compensations as large as 60 dB at either extreme of the audio spectrum (202), and (204) requires driver amplitude powers of less than 0.1 watts to produce a desired audio response at any frequency shown in FIG. 2. The average overall power requirement is considerably lower

Such earbud frequency outputs to achieve a “flat” response are readily implemented in digital systems by application of Digital Signal Processing (DSP) methods. The digital embodiment permits a precise change in the overall earbud frequency response in that a significant number of small sequential frequency regions can be addressed individually. The resultant sequence of amplitude/frequency variations then permits a precise corrected earbud output frequency response. This will eliminate the small irregularities in the overall response that remain with an analog approach to implementation the correction due to small sub-resonance effects.

The correction of the response curve (FIG. 2) is performed by a DSP circuit that divides the frequency range into a series of localized sections and providing the appropriate amplification correction to each of these regions. For example: near 200 Hz the correction would be for 16 db, at 1000 Hz 12 dB, at 10,000 Hz it would be 8 dB. The result would be a completely flat, frequency independent correction from 120 Hz to 24,000 Hz.

A second, independent control would then permit an increase/decrease of overall amplification that maintains the basic frequency correction values.

When in use, the earbuds form a closed system that is comprised of: a. The ear bud micro-speaker and the earbud tip pad, that provides a seal to the proximal end of the ear canal;

b. The ear canal itself; that is a tubular passage to the eardrum; and

c. The eardrum itself; that seals the distal end of the system.

When measuring the earbud micro-speaker response it is IMPORTANT that the above usage profile be replicated in the experimental measurement apparatus. As shown in FIG. 3, to this end, the apparatus uses a small rubber tube (302) with a thick wall. The earbud with a silicone rubber tip sealing the “proximal” end (304) is inserted into the tubular space (312). A small sensitive microphone (308) seals the opposite or “distal” end of the tube. The separation between earbud tip and microphone is about 10 mm more or less.

FIG. 2 shows one of several earbud measurements that illustrate the damped-resonant-micro-speaker characteristic of all earbud micro-speakers as measured in this manner.

The nature of the correction needed at various frequencies in order to provide a frequency independent sound output from the earbuds is illustrated in the following illustration, which indicates the magnitude of corrective amplification needed at some representative frequencies for the earbuds of FIG. 2:

| | | |
|---|---|---|
| @ 50 | Hz | 22 dB |
| @ 200 | Hz | 18 dB |
| @ 1000 | Hz | 13 dB |
| @ 3900 | Hz | 0 dB |
| @ 16000 | Hz | 13 dB |

The description of the invention is made with respect to FIG. 4. All components are enclosed in a case [400]. The sound source is, for example, a blue tooth-enabled MP3 player. This can be the MP3 player element of a smartphone, or a stand-alone blue tooth-enabled MP3 player. Other such enabled audio sources can be used.

The earbuds, (402) and (404) connect through port (422) via connection plug (420) An adapter plug, (424) permits the use of any standard earbud set that the user wishes to connect to the μFi.

The interior of the unit, [400], contains the following components:

The DSP electronics, [406] (as discussed above)

The externally programmable read/write memory of the DSP, [408]

The blue tooth receiver, [410]

The lithium-polymer battery, [412]

The charger/external programming port, [414]

The local control panel, [418]

The earbud connector port, [422]

Earbud port adapter [426] allowing use of conventional earbuds

A pair of microphones (428) and (432) for external sound listening

An in-line microphone [430] for “hands free” operation when needed.

The description of the μFi functionality is given below:

The blue tooth receiver [410] receives the media to be heard and transfers it to the input of the DSP unit [406] where the stored amplitude vs. frequency-information is used to provide the desired μFi hearing spectrum.

The enhanced sound is directed to the earbud port [422]. Mating connector [420] directs the stereophonic sound to the appropriate earbud [402] and [404].

When used with a smartphone in the “hands free” mode, the inline microphone (430) directs the speech of the user back to the voice transmission system of the smartphone thus providing a true “hands free” operation.

Control panel [418] permits selection of the various operational functions of the μFi. These are Selection of the specific earbud micro-speaker amplitude vs. frequency characteristic of the earbuds being used. Selection of the specific audiogram function to be used: Power off/on selection and: Earbud Speaker calibration operation.

When the “calibration” function is selected the right earbud must be pressed against the orifice of the left hand microphone [428]. Upon command from the control panel, the frequency scan of the earbud characteristic is initiated and the result stored in the memory section of DSP component [408]. This procedure will require less than 10 seconds. Then the new earbud set is calibrated and ready for use. By use of the earbud adapter [426] this feature permits the use of user-selected earbuds for optimum sound fidelity.

Alternatively, a pre-stored generic earbud amplitude-frequency characteristic can be used.

Microphones (428) and [432] can be enabled as a connection to the input of DSP element (408) for the left ear and right ear respectively to provide sounds from the external environment. This represents a safety feature for the user, as well as hearing assistance for the hearing impaired. It can be enabled/disabled from control panel (418).

Connection port [414] is used to recharge the lithium-polymer battery that provides the power source for the μFi. When connected to an external computer via a USB port the battery is charged. This same port can also be used to provide new programming to the DSP unit [406] and incorporated memory [408]. Thus additional features for the μFi can be added at future times.

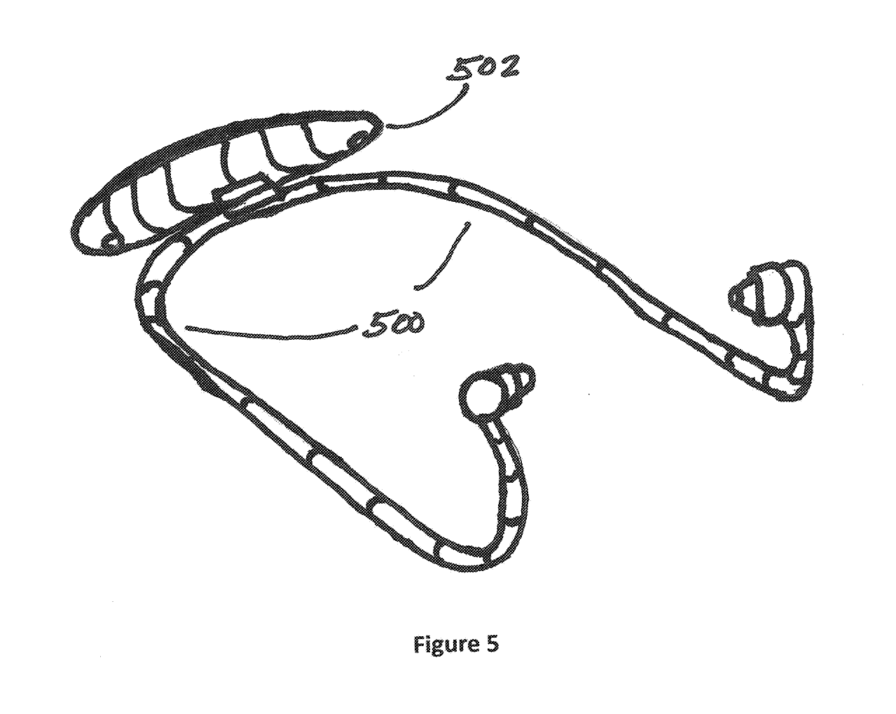

FIG. 5 illustrates one embodiment of the μFi and shows one relationship and style configuration possible (500). The section containing the battery, DSP unit, blue tooth unit, etc, (502) is light in weight and worn across the nape of the user's neck. Other embodiments are possible without impacting the operation of the invention.

When the sound source coupled to the micro-fidelity unit is a smartphone, such as an iPhone or a Galaxy, the μFi serves as a hands-free connection to the smartphone. The smartphone serves as a remote MP3 player when used as a music source. When used to receive/send a voice communication the Smartphone's earpiece speaker is disabled and the conversation is carried through the earbuds and the inline “hands free” microphone (430).

The voice sound is constrained by the bandwidth of the carrier network. In the United States the transmitted sound frequency range is from 400 Hz to 3400 Hz. This restricted 3000 Hz wide frequency range is also present in landline telephones. Since the frequency of normal speech ranges from a low value of about 80 Hz to about 8000 Hz, this restriction has a negative impact on speech comprehension.

The poor reproduction of sound over the 400 Hz-to-3400 Hz bandwidth and the unmodified earbud frequency response further compromise the received speech sounds. By using μFi corrected earbuds it is found that speech comprehension is dramatically improved. For this situation, most of the improvement is due to the restoration of the lower frequencies (from 400 Hz to 2500 Hz).

In foreign countries, a different bandwidth allocation permits sound reception to cover a significantly larger region (50 Hz to 7000 Hz). This increased sound bandwidth results in somewhat clearer speech and speech comprehension. Albeit at the expense of a factor of two allocation of bandwidth to conversations in already crowded communications channels. This certainly is one significant reason that the United States carriers have resisted change to this larger sound bandwidth (cost also is an important factor).

This patent also describes a direct modification to the driving circuits for smartphone earpiece-speakers. This modification significantly improves the sound quality that in turn improves speech comprehension for smartphones when they are used directly as a telephone with the earpiece speaker in close contact with the ear.

Because of their small size (11 mm to 16 mm), rectangular configuration, and confined space allocation in smart phones, these speakers exhibit considerable variations of amplitude response as a function of audio frequency. In addition, the audio frequency range provided by cell phone carriers is restricted to a 3000 Hz bandwidth (400 Hz to 3400 Hz in the United States) and it has significant impact on the speech frequency range of the human voice (about 40 Hz to 8000 Hz). This limitation also is present for landline telephone conversations and for the same reasons.

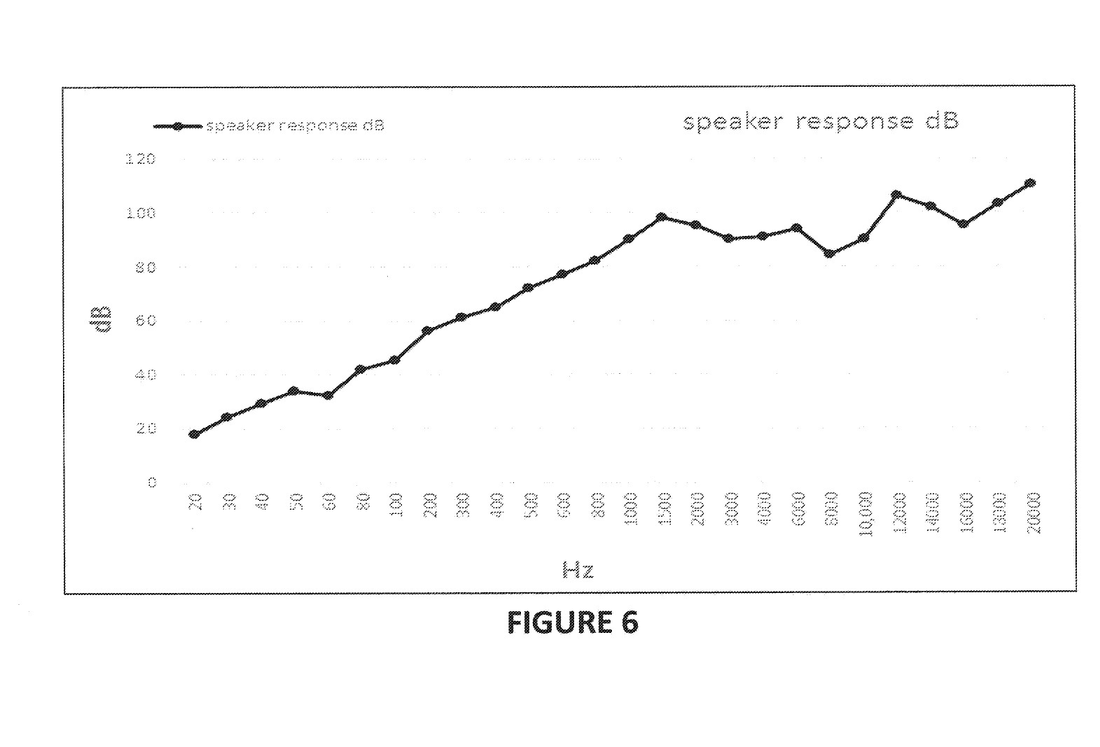

An additional very important factor in the issue of speech clarity and easy comprehension is in the transducer (earpiece micro-speaker) that produces the smartphone sounds. These micro-speakers must be small in order to fit inside the smartphone case. They are also configured as a rectangular speaker and the high frequency response has a reasonable good response above the basic resonance peak (about 950 Hz to 1000 Hz). FIG. 6 shows the amplitude vs. frequency response characteristic of a typical 11 mm×15 mm rectangular speaker. The response peaks near 1000 Hz then exhibits a dip of about 10 dB at 3000 Hz and rises as the frequency increases to 18000 Hz or so.

It must be pointed out that when the micro-fidelity instrument is used as a “hands-free” connection to the smartphone, the earpiece speaker is disabled and the correction is imposed on the earbud set being used with the μFi in its normal operation.

When the μFi is used in the “hands free” mode, the instrument can be reduced in size so that it can be small enough in size for use with one ear, with only one earbud speaker and with the required electronics (including the Bluetooth chip) and smaller lithium polymer battery it is easily worn while clipped on the user's ear.

The major feature of this response of the smartphone earpiece speaker is the extremely severe drop toward lower frequencies. The response has declined by 40 dB at 300 Hz and by about 60 dB at 100 Hz. This is the frequency region where the speech sounds of the vowels (a, e, I, o, u) and the basic consonants (m, n, g, d, j, v, z) reside. Such distortion for these lower tones of speech has a significant impact on speech comprehension.

For the rectangular smartphone speaker illustrated in FIG. 6 the necessary amplitude corrections at various frequencies are shown in the illustration below:

| | |
|---|---|
| Frequency | Amplification Required |

| | | | |
|---|---|---|---|
| 20 | Hz | 80 | dB |
| 50 | Hz | 64 | dB |
| 200 | Hz | 41 | dB |
| 1000 | Hz | 11 | dB |
| 1100 | Hz | 0 | dB |
| 3000 | Hz | 10 | dB |
| 10,000 | Hz | 9 | dB |
| 20,000 | Hz | −10 | dB |

It is clear from this information that all significant corrections are made for frequencies below 1100 Hz and that such corrections will significantly enhance speech comprehension.

This sound variability over the limited available frequency bandwidth causes substantial issues for easy speech comprehension in telephone conversations. While it is not possible to change/modify the issue of the limitation of available sound bandwidth imposed by the fundamental limitations of the system itself, it is clearly possible to optimize the sound reproduction properties of the small speakers used in telephones over the available audio bandwidth.

Even for the newer “high definition” networks, available in countries other than the United States, that have a much greater transmission bandwidth (50 Hz to 7000 Hz) the basic nonlinear response of the speakers in all telephones (land lines and cellular lines) has a significant impact on communication comprehension.

We propose a significant improvement of the earpiece speaker response via a new and novel modification of the speaker drive circuits of the telephones, both cell phones and land line telephones. The proposed modification approach can be extended from phones with such modifications for received speech to the transmission of such modified sound signals to the receiving phone so that both phones can benefit from the modifications.

The basic elements of the earbud modification, with straightforward fixed functionality, will be a physically small DSP digital circuit chip, a digital signal processor (DSP). This DSP changes the sound quality of smartphone (and all telephone) earpiece micro-speakers over the frequency range from 20 Hz to 16,000 Hz. The change is designed so that the quality of the heard sound provides a much-improved comprehension of speech. Even though the 16000 Hz high frequency range is well above the phone's upper bandwidth range the correction effectiveness overall is better when this range is used in the design.

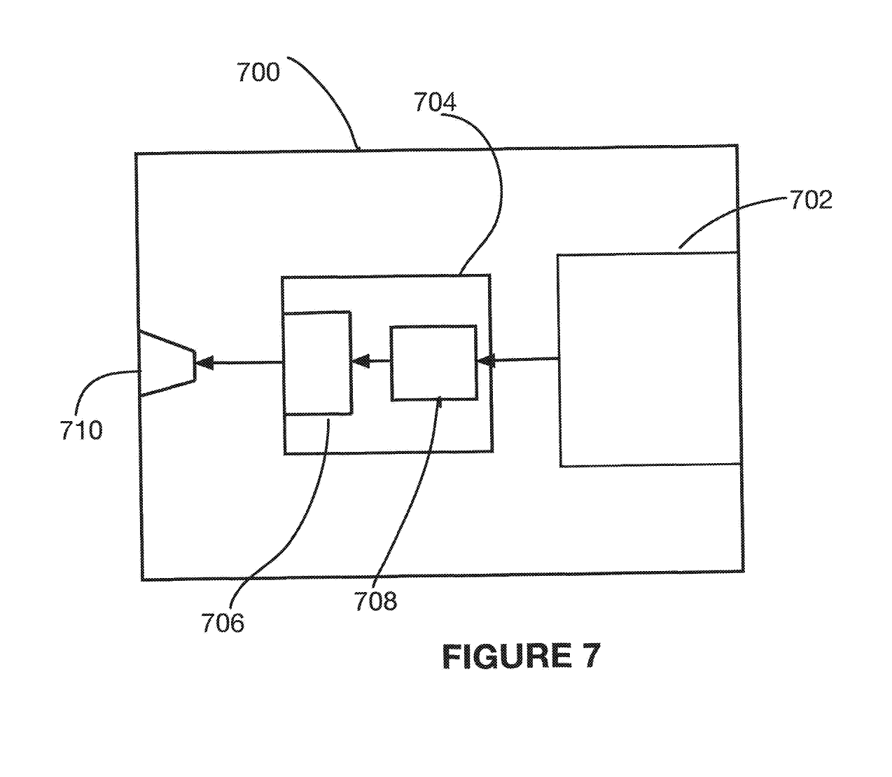

FIG. 7 shows a block diagram of the modifications that are to be added to the smartphone for speech comprehension enhancement (SCE). The entirety of the FIG. [700] represents the modified smartphone. Element (702) shows the voice channel output, normally connected directly to the earpiece micro-speaker [710]. The SCE circuit [704] is positioned into the voice channel between the voice channel output [702] and the micro-speaker [710]. The SCE circuit [704] has two basic components; DSP circuit [708} and power amplifier circuit [706]. Circuit [708] provides the proper filter modifications to the incoming voice channel [702] to correct the signal output properly. The power amplifier [706] then boosts the needed signal power to the output micro-speaker [710]. The power amplifier is necessary since the required heavy filtering effect of the DSP [708] requires this added power for proper sound reproduction.

All these functions can be provided by a single small solid-state electronic chip that can be added to any smart phone without requiring any changes in physical space changes in the smartphone. Additionally it is possible/probable that the existing processing power inside all smartphones is sufficient that only some additional programming will permit the incorporation of this smartphone modification for SCE use.

Finally, these circuits can be used to provide an overall substantial amplification of sound, which would be useful for listening in a noisy environment.

This modification will also provide a modest boost to speech sounds at frequencies greater than 1000 Hz (to 12000 Hz). This additional correction provides a modest help for those that suffer from presbyacusis (age-related hearing loss) while at the same time not causing any distortion of sound for others.

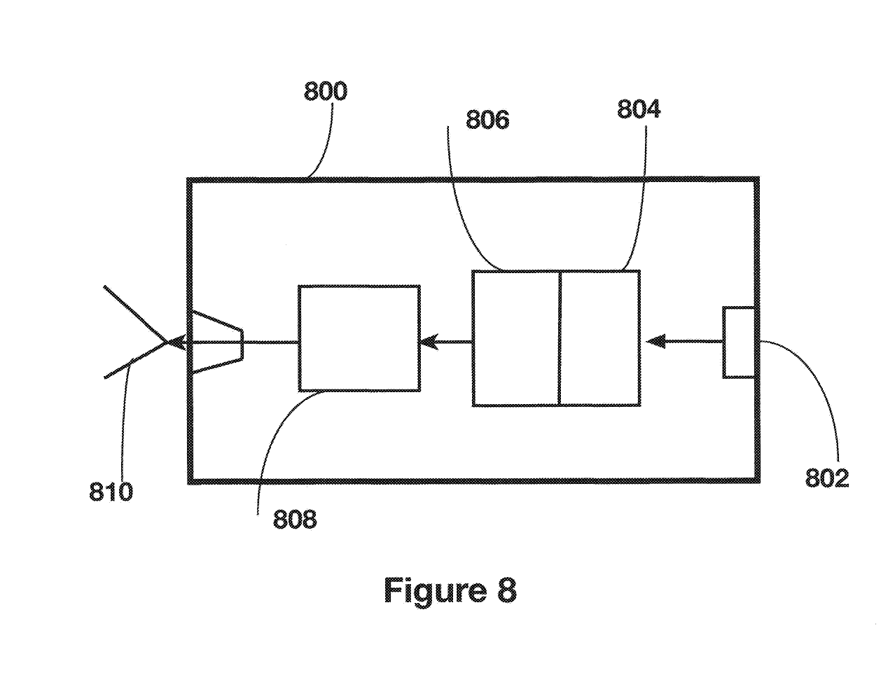

One additional and very significant feature of this method of changing the frequency response for smartphone earpiece is that is possible to impose this same modification onto the sound transmitted by the smartphone. This means that the receiving telephone can have the same earpiece speaker response for better comprehension even if the circuits are not included in their phones. With reference to FIG. 8, the components (804) and (806) are connected to the Smartphone's microphone (802). The output of the SCE is then sent to the transmitting circuit (808) and then to the transmitting antenna (810). This imposes the speaker correction of FIG. 6 onto the transmitted voice sound. This provides the smartphone with enhanced speech comprehension.

The remote and unmodified phone's voice transmission can be detected by the modified phone, and the information about the receiving phone's capability can be detected so that a go/no-go decision regarding the transmission of modified speech can be imposed.

This embodiment of the invention will be very useful and important to call centers, corporate trouble shooting centers, and other organized call-in organizations. It will make all telephone voice communications much more comprehension friendly, regardless of the type of telephone used, cell phone or landline telephone.

This type of correcting the frequency response of a receiving telephone provides a significant improvement of speech comprehension that improves the efficiency and usefulness of operation for call centers, corporate trouble shooting operations, and general ease of communications, especially between individuals that do not otherwise know one another. Telephone speech comprehension is especially stressful between strangers and this facet if this invention significantly reduces that stress.

What is claimed is:

1. A hearing instrument comprising:
a first component that provides amplification of an acoustic input signal;
the first component provides an amplification that varies in magnitude as a function of the acoustic frequency of sound;
earbuds to connect to the instrument to carry sounds to the user's ears;
the first component and control function circuits are contained in a case that is worn by the user;
wherein the earbuds can be connected permanently to the instrument;
wherein the instrument or can be connected to commercially available earbuds via an industry standard receptacle adapter component;
wherein a blue tooth transmitter and receiver, known as a “transceiver” is included inside the instrument case;
wherein the blue tooth transceiver can receive sound signals from dedicated MP3 players or other such sources;
wherein the blue tooth transceiver can receive sound signals from smartphones.

2. A hearing Instrument according to claim 1, wherein the first component contains a DSP solid-state circuit capable of modifying the acoustic output spectrum of an earbud set so that the amplification of sound can be modified in a controlled manner as a function of the sound frequency over the range from 16 Hz to 24,000 Hz.

3. A hearing Instrument according to claim 1, wherein the instrument DSP component contains a digital memory section that stores information about: (a.) the acoustic response characteristic of earbuds; and (b) an audiogram that describes the hearing characteristic that is typical of the user of the device.

4. A hearing Instrument according to claim 1, wherein the instrument components include a lithium polymer battery that provides operating power for at least 24 hours.

5. A hearing Instrument according to claim 1, wherein the instrument components have a connection port that permits connection of a DC charging circuit for charging the battery.

6. A hearing Instrument according to claim 1, wherein the instrument component has a control panel that permits a user to: control volume for each ear; power on/off for the instrument.

7. A hearing Instrument according to claim 1, wherein the selection of the mode of operation of the complete instrument (hearing, listening, etc.); selection of memory elements to be used; and other functions that are deemed appropriate and necessary are included as functions of the control panel.

8. A hearing Instrument according to claim 1, wherein provisions are made for inserting the frequency response of a set of data elements that characterize the earbuds being used to control the resultant operation of the instrument so as to provide a frequency independent high fidelity hearing performance of the instrument that relates uniquely to that earbud set.

9. A hearing Instrument according to claim 1, wherein the provisions are made for the insertion of a set of prerecorded audiogram basic features that permit the electronic compensation of hearing deficiencies that are reflected in the audiograms of users.

10. A hearing Instrument according to claim 1, wherein the audiogram has a characteristic which is independent of audio frequency so that the corrections for the earbuds that is independent of the audio frequency for the individual to whom the audiogram relates;

11. A hearing. Instrument according to claim 1, wherein the apparatus, for automatically measuring this micro-speaker characteristic and inserting the resultant audio spectrum into the memory of the instrument, is provided;

12. A hearing instrument according to claim 1, wherein the streaming of music from providers can be implemented via an added Wi-Fi component.

13. The instrument according to claim 1 in which the instrument is connected to a smartphone, MP3 player or other audio source via a Bluetooth device.

14. An instrument according to claim 1 in which the instrument is configured as a small device that is to be worn mounted on one ear of the user.

15. The method of using a hearing instrument comprising the steps of: sound modification provided by the instrument when connected to a smartphone via a Bluetooth connection provides frequency independent correction to smartphone-received vocal communications over the smartphone carrier's sound reception bandwidth that enhances speech comprehension for the listener.

16. A method according to claim 15 further comprising providing a modification of the internal circuits of a smart phone to include a DSP component in order to provide enhanced speech comprehension during smartphone telephone conversations by use of the speaker correction methods that use the earpiece speaker included inside the smartphone.

17. A method according to claim 15 of providing a modification/addition to telephone electric circuits to permit the sending of speech audio content that has been modified by the use of this invention and is transmitted to a second smartphone/telephone to anyone receiving the speech information on a smartphone or conventional landline telephone such that the speech comprehension of the receiving instrument is enhanced accordingly.

18. A method according to claim 15 in which the corrections of the earpiece speaker of smartphones to produce a frequency independent response are provided by the carrier entity that provides the connection service for their connected cell phones.
